(19) United States
(12) Patent Application Publication
(10) Pub. No.: US 2018/0207703 A1
(43) Pub. Date: Jul. 26, 2018

(54) SYSTEM AND METHOD FOR PUNCHING AND ATTACHING TO FASCIA

(71) Applicant: FORD GLOBAL TECHNOLOGIES, LLC, Dearborn, MI (US)

(72) Inventors: LaRon Michelle BROWN, Birmingham, MI (US); Michael WILLIAMS, Northville, MI (US); Flondezi GODETTE, Saline, MI (US); Rebecca SCALA, Woodhaven, MI (US)

(73) Assignee: FORD GLOBAL TECHNOLOGIES, LLC, Dearborn, MI (US)

(21) Appl. No.: 15/744,440

(22) PCT Filed: Aug. 27, 2015
(86) PCT No.: PCT/US15/47088

§ 371 Date: Jan. 12, 2018

(51) Int. Cl. B21D 28/26; B60R 13/04; B25J 11/00; B25J 15/00

(52) U.S. Cl. CPC B21D 28/26; B60R 13/04; B25J 11/008; B25J 15/0066; B25J 15/008; B25J 11/005

(57) ABSTRACT

Systems and methods for punching and attaching components to vehicle fascia are disclosed. The system may include a first robot including a punching end of arm tool (EOAT) and configured to punch openings in a vehicle fascia and a second robot configured to attach components having an adhesive applied thereto to the vehicle fascia adjacent to the openings. The system may further include a third or more robots configured to attach components to the vehicle fascia. The method may include punching one or more openings into a vehicle fascia using a first robot EOAT and placing and holding the one or more components having adhesive applied thereto in contact with the vehicle fascia adjacent to the one or more openings using a second EOAT. The system and method may provide flexibility, scalability, and cost effectiveness to the punching and attaching process.

### TECHNICAL FIELD

This disclosure relates to systems and methods for punching and/or attaching components to fascia, such as a vehicle fascia.

### BACKGROUND

In the automotive industry, it is sometimes necessary to form holes in and/or attach components to a vehicle fascia. One example may include forming a hole for a sensor, such as an object detection sensor or a camera. To hold or support the sensor on a rear or “B-side” of the fascia, a bracket or mount may be used. In current vehicles, the forming of the hole and the attachment of the bracket to the fascia are both generally performed using sonic equipment. For example, the hole may be formed using a sonic punch fixture and the bracket may be attached by sonic welding.

### SUMMARY

In at least one embodiment, a system is provided comprising a first robot including a punching end of arm tool (EOAT) and configured to punch one or more openings in a vehicle fascia; and a second robot configured to attach one or more components having an adhesive applied thereto to the vehicle fascia adjacent to the one or more openings.

The first robot may be configured to sequentially punch a plurality of openings in the vehicle fascia. In one embodiment, the first robot is configured to punch the one or more openings at one or more variable locations on the vehicle fascia. The second robot may be configured to apply the adhesive to the one or more components prior to attaching the one or more components to the vehicle fascia. In one embodiment, the second robot is configured to hold the one or more components under an adhesive dispenser prior to attaching the one or more components to the vehicle fascia. The second robot may be configured to plasma treat or flame treat at least one of the vehicle fascia and the one or more components prior to attaching the one or more components to the vehicle fascia.

The second robot may be configured to sequentially attach a plurality of components having an adhesive applied thereto to the vehicle fascia adjacent to the one or more openings. In one embodiment, the second robot is configured to attach the one or more components having an adhesive applied thereto to the vehicle fascia at one or more variable locations on the vehicle fascia. The second robot may be configured to switch between an adhesive dispensing EOAT and a grasping EOAT, wherein the second robot is configured to apply adhesive to the one or more components using the adhesive dispensing EOAT and to attach the one or more components using the grasping EOAT. The one or more components may include sensor brackets and the second robot may be configured to attach one or more components having a hot melt adhesive applied thereto to the vehicle fascia adjacent to the one or more openings.

In at least one embodiment, a method is provided comprising punching one or more openings into a vehicle fascia using a first robot end of arm tool (EOAT); applying adhesive to one or more components; and placing and holding the one or more components in contact with the vehicle fascia adjacent to the one or more openings using a second EOAT to attach the one or more components to the vehicle fascia.

The punching step may be performed by a first robot and the placing and holding step may be performed by a second robot. The punching step may include sequentially punching a plurality of openings into the vehicle fascia using the first EOAT. The adhesive may be applied to the one or more components by a third EOAT. In one embodiment, the placing and holding step includes sequentially placing and holding a plurality of components in contact with the vehicle fascia adjacent to the one or more openings using a second EOAT. The adhesive may be applied to the one or more components by an adhesive dispensing EOAT coupled to a robot and the placing and holding step may be performed by the same robot after the robot switches to a grasping EOAT. In one embodiment, the applying step includes applying a hot melt adhesive to one or more components and the one or more components include sensor brackets.

In at least one embodiment, a system is provided comprising a first robot including a punching tool and configured to punch a plurality of openings in a vehicle fascia; a second robot configured to attach one or more components having an adhesive applied thereto to the vehicle fascia adjacent to one of the openings; and a third robot configured to attach one or more components having an adhesive applied thereto to the vehicle fascia adjacent to one of the openings.

The system may further include a nest configured to receive the vehicle fascia from the first robot after the plurality of openings are punched and to hold the vehicle fascia while the second and third robots attach the one or more components. The nest may be configured to move from the second robot to the third robot.

### BRIEF DESCRIPTION OF THE DRAWINGS

FIG. 1 is a schematic of a two-robot production cell for punching a fascia and attaching components thereto, according to an embodiment;

FIG. 2 is an example of a flowchart for operating the production cell of FIG. 1, according to an embodiment;

FIG. 3 is a schematic of a four-robot production cell for punching a fascia and attaching components thereto, according to an embodiment;

FIG. 4 is an example of a flowchart for operating the production cell of FIG. 3, according to an embodiment;

FIG. 5 is an example of a cycle time schedule for the production cell of FIG. 3, according to an embodiment; and

FIG. 6 is a perspective view of a robot having a tool changer that may be used to punch and/or attach components to a fascia, according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As described above, holes are currently generally formed in vehicle fascias using sonic punching fixtures and attaching components, such as brackets, to the fascias is generally performed using sonic welding. Manufacturers have generally favored sonic punch/weld fixtures because they are a single-step—the fascia is loaded into the equipment and come out with the holes punched and the brackets welded. However, there are several drawbacks to the use of sonic equipment. For example, since multiple holes are punched at once, the current sonic welding process requires a unique and separate sonic weld tooling fixture for each fascia variant and model design. Front and rear fascias may not share sonic weld fixtures, making the investment in equipment extensive and making re-tooling for product variants, new model changes, and/or low volume programs very costly. In addition, different countries may have different sensor requirements; therefore, a single vehicle model may require different fixtures for different countries. The fixtures are essentially fixed structures and cannot be easily or quickly modified to accommodate a new set of punch configurations. A single sonic welding fixture may cost half a million dollars or more, making each additional fixture configuration a significant cost.

The maintenance and storage of the tooling fixtures is another additional cost, and maintaining storage space can become cost prohibitive if the tooling must be stored for a certain service period (e.g., 10 years). In addition, the use of sonic welding may require thicker fascia sections to eliminate sonic weld read-through onto the “Class A” surface (e.g., seeing an outline of the sonically welded region). This may reduce opportunities to develop fascias with reduced nominal wall thickness, which can reduce weight and costs. Thus, while the combination of fixed sonic punch fixtures and sonic welding has been widely adopted for its simplicity and ease of use, it is inflexible and costly, particularly as the number of models or variants increases.

Accordingly, systems and methods for forming holes and attaching to fascias without sonic punch fixtures and sonic welding are disclosed. The systems may include at least one robot, for example two or more robots, which may punch holes in the fascia and attach components (e.g., brackets) using an adhesive. In at least one embodiment, there may be at least one punching robot and at least one adhesive robot. Each punching robot may punch one or more holes in the fascia, which may be done one at a time in a sequential manner. The location and number of holes to be punched may be programmed into the robot or robot controller, for example using robotic process automation (RPA). Accordingly, the number and position of the holes to be punched is extremely flexible in the disclosed systems, in contrast to the rigid sonic punching fixtures. If the configuration of the holes is changed or a different vehicle fascia is to be punched, a new, high-cost fixture is not required, the robot only needs to be re-programmed with the new hole configuration.

The system may include at least one robot that applies an adhesive to the component to be attached to the fascia and attaches the component (an adhesive robot). Similar to the punching robot(s), the adhesive robot(s) may be programmed to attach a component (e.g., a bracket) in a certain location. The robot may sequentially apply adhesive and attach multiple components, making the number of components flexible. The location of the attachment is also flexible, and may be reprogrammed if the bracket configuration is changed or for a new/different fascia. Accordingly, the disclosed systems and methods may be very versatile and able to adapt to changes in vehicle models/platforms, design changes, changes in designs between countries, or other adjustments. The systems may also reduce the cost of low-volume production by avoiding the need to purchase an expensive fixture that is specifically designed for the configuration at issue. The system may also reduce or eliminate the cost and space associated with keeping and storing fixtures for each configuration. The systems can also scale based on the speed and/or volume required. For example, if more holes need to be punched per fascia, additional punching robots may be added to the system. Similarly, if the number of components being attached increases, additional adhesive robots may be added to the system. If the overall volume of fascias being produced increases, additional punching and/or adhesive robots may be added to meet the demand.

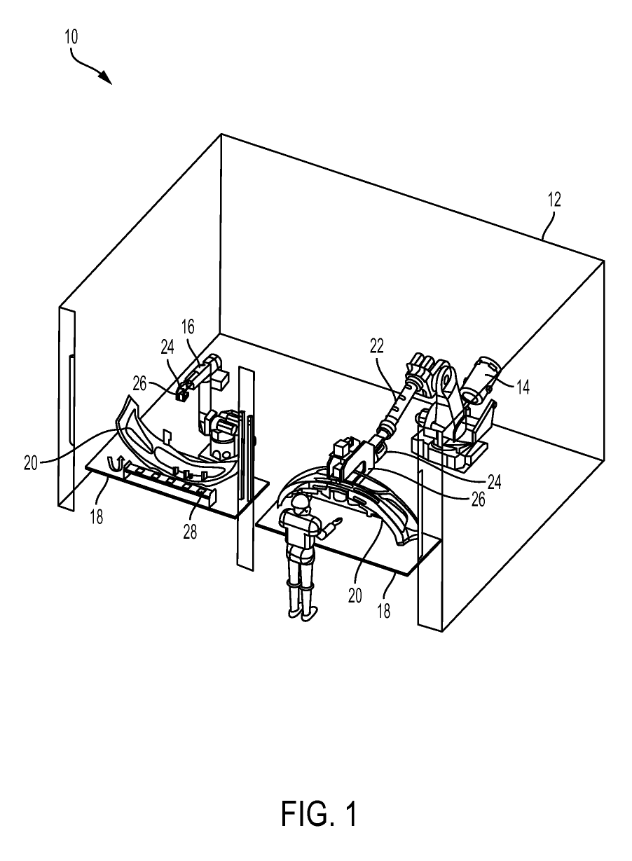

With reference to FIG. 1, an embodiment of a system 10 is shown including a punching robot 14 and an adhesive robot 16. The robots may be contained or assigned to a production cell 12. Each robot may have a corresponding nest 18, which may be configured to hold a fascia 20. While each robot is shown having individual nests 18, a single nest may service both robots or there may be more nests than robots (e.g., they may rotate in and out). The nests 18 may hold the fascia 20 in any suitable manner to allow the punching and/or attaching processes. For example, the nests may include clamps (manual or automated, not shown) to hold the fascia 20 in a fixed position. Alternatively, the nests 18 may include straps, tie downs, or mechanical fasteners (e.g., screws, hook and loop fasteners, etc.), or any other releasable holding mechanism. The nests may also have a surface shape or contour that is configured to receive the fascia 20 without requiring fasteners or clamps. For example, the nests 18 may have a concave or bowl-like shape that is configured to match or correspond to a curved shape of the fascia 20.

The punching robot 14 may have an arm 22, which may have multiple axes of rotation, such as 3, 4, 5, 6, 7, or more axes of rotation. The arm 22 may include a tool changer 24, which may be a quick change (QC) tool coupler or automatic tool changer (ATC). The tool changer 24 may allow the robot 14 to change tools quickly by either replacing the currently attached tool or by having more than one tool attached and rotating or otherwise switching between the tools. Attached to the tool changer 24 may be a tool 26 or multiple tools 26. For the punching robot 14, the tool 26 may be a punching tool. In one embodiment, the tool 26 may be a mechanical punching tool, wherein the tool physically cuts or otherwise severs the material from the surrounding fascia.

In one embodiment, the mechanical punch may be a servo-driven punch. For example, the mechanical punch may be a 7^{th} axis servo in which the power transmission path is from an auxiliary axis servo motor, through a gear reducer driving a ball screw to convert the rotary servo motor motion to a linear punch motion. The mechanical punch may include a punch component and a punch receiver component. When making the punch, the punch component and punch receiver component may be on opposite sides of the fascia wall to be punched. In one embodiment, the tool may include a clamp having the punch component and punch receiver component. The clamp may have a “C” shape (e.g., two parallel faces connected by a perpendicular face) that may apply force to the fascia and allow for force absorption during the punch. The robot may be programmed to have a certain punch depth, which may be used to generate an edge radius on the A-surface. The parameters of the punch process, such as acceleration, deceleration, velocity, force, angle, and other, may all be programmed into the punching robot 14.

In another embodiment, the tool 26 of the punching robot 14 may be a non-mechanical punch, in that it forms a hole or opening without mechanically cutting the material away. One example of non-mechanical punching may be sonic punching. A sonic punch tool may be attached to the robot 14 to perform single punching actions. This is in contrast to the sonic punching fixtures described in the Background section, in which a plurality of punches are performed at once in a fixture configured for a specific punch layout. In the disclosed system, the tool 26 may include a sonic punch that may be programmed to perform a single punching action multiple times. The sonic punch may therefore become flexible and programmable, similar to the mechanical punching tool described above. Other methods of forming openings in the fascia may also be used, such as laser cutting and rotary die cutting.

The adhesive robot 16 may have an arm 22, which may have multiple axes of rotation, such as 3, 4, 5, 6, 7, or more axes of rotation. The arm 22 may include a tool changer 24, which may be a quick change (QC) tool coupler or automatic tool changer (ATC). The tool changer 24 may allow the robot 14 to change tools quickly by either replacing the currently attached tool or by having more than one tool attached and rotating or otherwise switching between the tools. Attached to the tool changer 24 may be a tool 26 or multiple tools 26. For the adhesive robot 16, the tools 26 may include a grabber/grasper tool and/or a plasma/flame treatment tool. If there are multiple tools, the robot may be programmed to switch tools or rotate tools using the described QC or ATC components.

In at least one embodiment, the component 28 to be attached to the fascia 20 may be plasma treated prior to attachment. The plasma treatment may be performed by the adhesive robot 16 or the adhesive robot 16 may hold the component 28 to be treated under a plasma treatment source. In one embodiment, the adhesive robot 16 may include a plasma treatment tool and may apply plasma to the component 28. The plasma treatment may be an air plasma, and may increase the surface energy of the component 28 such that an adhesive forms a better bond with the component 28. In addition to, or instead of, plasma treating, the component 28 and/or fascia 20 may be flame treated. Similar to plasma treatment, flame treatment may be performed by a flame treatment tool attached to the robot arm or the robot may hold the component 28 under a flame treatment source.

After the (optional) plasma and/or flame treatment has been performed, the adhesive robot 16 may switch the tool 26 to a grabber tool (if not already selected). The grabber tool may then pick up the component 28 (e.g., a bracket for a sensor) and position it to receive an adhesive. For example, an adhesive dispenser (not shown) may be located within reach of the arm 22 and may be configured to dispense adhesive onto the component when the component 28 is in position. The adhesive dispenser may dispense the adhesive automatically or it may be manually activated. If automatic, the adhesive dispenser may have a motion detection system or the dispensing may be based on timing or other methods.

After the adhesive is applied to the component 28, the robot 16 may place the component 28 in contact with the fascia 20 in the programmed location and hold it in place for a time sufficient for the adhesive to take effect. The hold time may depend on the adhesive, and may be programmed into the robot. Some adhesives may require a hold time sufficient for the adhesive to dry or cure, while others may only require partial drying or curing before the robot 16 can cease to hold the component 28 in place. The robot 16 may repeat the plasma, adhesive, and hold steps for each component 28 that is to be attached to the fascia 20. For example, if a fascia is configured to have five sensors, cameras, or other devices mounted thereto, the robot may sequentially plasma-treat a bracket, apply adhesive to the bracket, and hold the bracket in position, and then repeat those steps four more times (one cycle for each bracket).

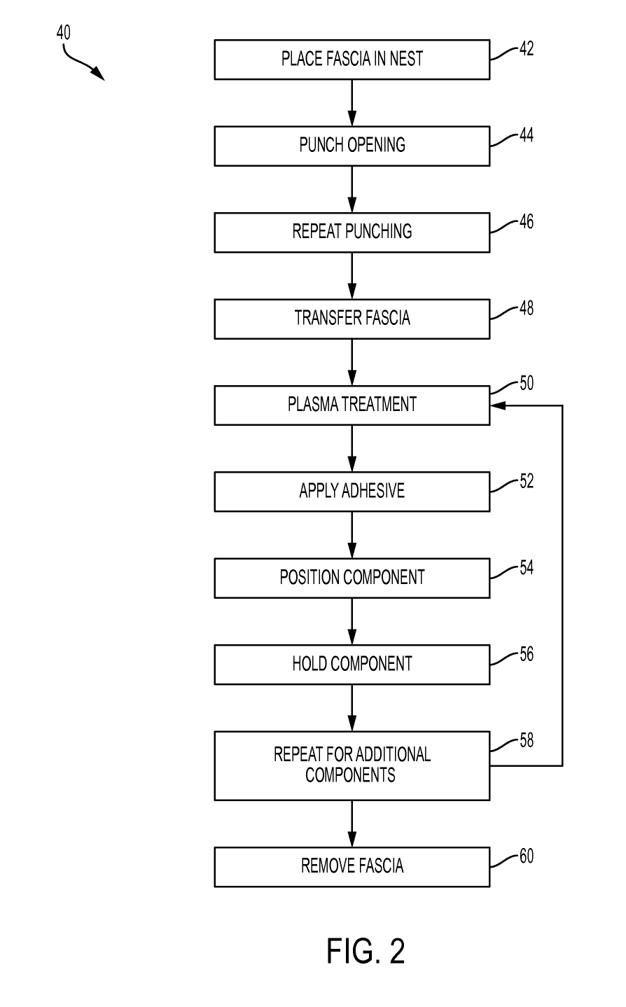

With reference to FIG. 2, an example flow chart 40 is shown for a method of operating the system shown 10 in FIG. 1. In step 42, a fascia may be placed, inserted, or clamped into a nest near or adjacent the punching robot. The fascia may be placed in the nest manually (e.g., by a person) or it may be placed by a separate robot or other machinery. During this step, the number of components to be attached to the fascia by the adhesive robots may be loaded onto the nest for the adhesive robot. Loading of the components may be done at any time, however, and may be separate from the loading of the fascia into the punching robot nest. In step 44, the punching robot may punch an opening or hole into the fascia in a first punching step performed by a robot end of art tool (EOAT). The punch may be performed using any suitable method, such as mechanical punching or sonic punching. The punching location may be programmed into the robot or the robot controller. In step 46, a second punching step may be performed in a manner similar to that of step 44 to form an opening in a second location. Step 46 may be repeated multiple times to form a designated number of openings. Each punch location may be programmed into the robot or robot controller. While a second (and subsequent) punch is shown, there may be only a single punch. Any number of openings may be formed using the punching robot, making the process extremely flexible and reprogrammable.

After the last hole has been punched by the punching robot, the fascia may be transferred to another nest near or adjacent the adhesive robot in step 48. The fascia may be transferred to the second nest manually or by a separate robot or other machinery. In optional step 50, the components to be attached to the fascia, such as brackets, may be plasma treated and/or flame treated. The plasma and/or flame treatment may be applied by a plasma/flame treatment EOAT on the adhesive robot or the adhesive robot may grab/grip the component and hold it in position under a plasma/flame treatment source to receive a plasma/flame treatment (e.g., air plasma). The components may also be treated in another location before being brought to the production cell. Alternatively, or in addition, the fascia 20 may be plasma/flame treated, either on the entire B-surface or only in the regions where the components will be attached. If the fascia 20 is plasma/flame treated, it may be performed by the adhesive robot 16 or by a separate robot.

In step 52, an adhesive may be applied to the component in an area where it is configured to be attached to the fascia. The adhesive may be any suitable adhesive, such as a hot melt adhesive. Examples of suitable hot melt adhesives may include ethylene-vinyl acetate (EVA) copolymers, polyolefins (e.g., PE or PP), polyamides, polyesters, polyurethanes, styrene block copolymers, polycarbonates, fluoropolymers, silicones, thermoplastic elastomers, or others. The heating temperature of the hot melt adhesive may depend on the composition. The adhesive may be applied in a similar manner to the plasma treatment. For example, the adhesive may be applied by a adhesive dispensing EOAT on the adhesive robot or the adhesive robot may grab/grip the component and hold it in position under an adhesive dispenser to receive a shot or dose of adhesive.

Depending on how the plasma treatment and adhesive are applied, the adhesive robot may change or rotate tools during steps 50 and 52. For example, if the plasma treatment is applied by the robot in step 50, it may switch to a grasping tool to pick up the component and hold it under an adhesive dispenser in step 52. Other combinations of tool changes or rotations may occur depending on the specific configuration of the system. If the adhesive robot does not directly apply the plasma treatment or the adhesive, it may have only a gasping tool to pick up and position the components to receive the treatment/adhesive.

Once the component has been plasma treated and has received adhesive, the adhesive robot may position the component in contact with a programmed location on the fascia to attach the component to the fascia in step 54. For example, if the component is a bracket for a rear-facing camera on a rear bumper, the robot may position the bracket near or adjacent an opening in a center region of the fascia. Once the robot has placed the component in contact with the fascia, it may hold the component in that position in step 56 for a certain length of time to allow the adhesive to solidify, cure, or otherwise harden such that the component will not move when support is removed. For example, the hold time may be at least 1 second, such as 1 to 60 seconds, 1 to 30 seconds, 1 to 20 seconds, 1 to 15 seconds, 5 to 30 seconds, 5 to 20 seconds, 5 to 15 seconds, or 10 to 15 seconds.

After the first component has been attached to the fascia, additional components may be subsequently attached in step 58, which may include repeating steps 50-56. The components may be sequentially attached (e.g., one at a time) by repeating step 58 until all the designated components have been attached to the fascia. In step 60, the fascia may be removed from the nest for further processing or for assembly. The removal may be manual (e.g., by a person), or by another robot or machinery.

While two robots are shown in system 10 and described in flowchart 40, there may be additional robots or multiples of the two robots (e.g., 2 sets of 2 robots, etc.). For example, if the punching operation is faster than the adhesive operation, then there may be more adhesive robots than punching robots in order to avoid bottlenecks. Two or more adhesive robots may apply components to a single fascia, or one robot may plasma treat while another applies adhesive and a third could position and hold the component in place. Based on the present disclosure, one of ordinary skill in the art may formulate different combinations of numbers of robots and their individual tasks. If greater production volumes are desired, then multiple production cells may be formed in the system. For example, there may be multiple sets of punching robots and adhesive robots performing the same tasks.

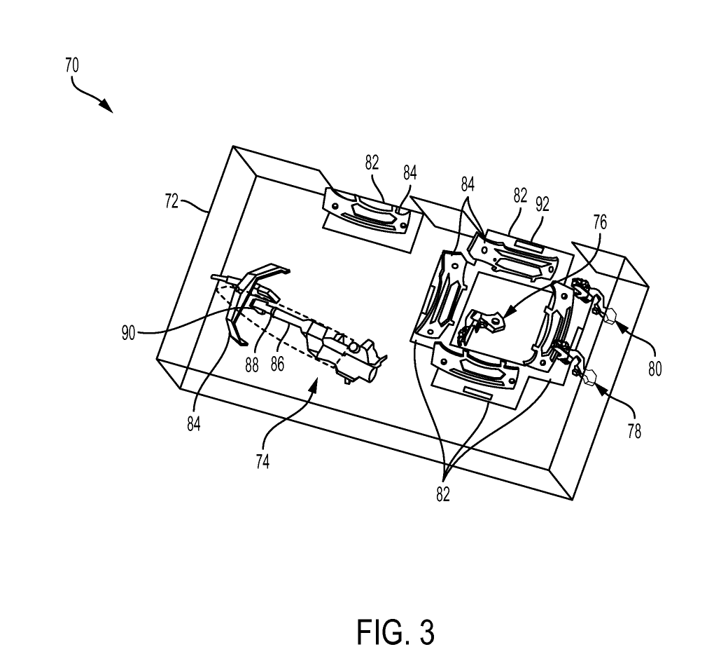

With reference to FIG. 3, an embodiment of a system 70 is shown with a production cell 72 including a punching robot 74 and three adhesive robots 76, 78, and 80. The system 70 may include a plurality of nests 82 configured to hold and/or support fascias 84. The nests may include clamps (manual or automated, not shown) to hold the fascia 84 in a fixed position. Alternatively, the nests 82 may include straps, tie downs, or mechanical fasteners (e.g., screws, hook and loop fasteners, etc.), or any other releasable holding mechanism. The nests may also have a surface shape or contour that is configured to receive the fascia 84 without requiring fasteners or clamps. For example, the nests 82 may have a concave or bowl-like shape that is configured to match or correspond to a curved shape of the fascia 84. Each robot may have a corresponding nest 82, some robots may share a nest 82, and/or some robots may have two or more nests 82. The nests 82 may be fixed, or one or more nests may be configured to move or rotate between the robots.

The punching robot 74 may be similar to the punching robot 14, described above. The punching robot 74 may have an arm 86, which may have multiple axes of rotation, such as 3, 4, 5, 6, 7, or more axes of rotation. The arm 86 may include a tool changer 88, which may be a quick change (QC) tool coupler or automatic tool changer (ATC). The tool changer 88 may allow the robot 74 to change tools quickly by either replacing the currently attached tool or by having more than one tool attached and rotating or otherwise switching between the tools. Attached to the tool changer 88 may be a tool 90 or multiple tools 90. For the punching robot 74, the tool 90 may be a punching tool. In one embodiment, the tool 90 may be a mechanical punching tool, wherein the tool physically cuts or otherwise severs the material from the surrounding fascia.

In one embodiment, the mechanical punch may be a servo-driven punch. For example, the mechanical punch may be a 7^{th} axis servo in which the power transmission path is from an auxiliary axis servo motor, through a gear reducer driving a ball screw to convert the rotary servo motor motion to a linear punch motion. The mechanical punch may include a punch component and a punch receiver component. When making the punch, the punch component and punch receiver component may be on opposite sides of the fascia wall to be punched. In one embodiment, the tool may include a clamp having the punch component and punch receiver component. The clamp may have a “C” shape (e.g., two parallel faces connected by a perpendicular face) that may apply force to the fascia and allow for force absorption during the punch. The robot may be programmed to have a certain punch depth, which may be used to generate an edge radius on the A-surface. The parameters of the punch process, such as acceleration, deceleration, velocity, force, angle, and other, may all be programmed into the punching robot 74.

In another embodiment, the tool 90 of the punching robot 74 may be a non-mechanical punch, in that it forms a hole or opening without mechanically cutting the material away. One example of non-mechanical punching may be sonic punching. A sonic punch tool may be attached to the robot 74 to perform single punching actions. This is in contrast to the sonic punching fixtures described in the Background section, in which a plurality of punches are performed at once in a fixture configured for a specific punch layout. In the disclosed system, the tool 90 may include a sonic punch that may be programmed to perform a single punching action multiple times. The sonic punch may therefore become flexible and programmable, similar to the mechanical punching tool described above. Other methods of forming openings in the fascia may also be used, such as laser cutting or rotary die cutting.

The three adhesive robots may be referred to as the first adhesive robot 76, second adhesive robot 78, and third adhesive robot 80. The adhesive robots 76, 78, and 80 may be similar to adhesive robot 16, described above. The adhesive robots may each have an arm 86, which may have multiple axes of rotation, such as 3, 4, 5, 6, 7, or more axes of rotation. The arm 86 may include a tool changer 88, which may be a quick change (QC) tool coupler or automatic tool changer (ATC). The tool changer 88 may allow the robots to change tools quickly by either replacing the currently attached tool or by having more than one tool attached and rotating or otherwise switching between the tools. Attached to the tool changer 88 may be a tool 90 or multiple tools 90. For the adhesive robots, the tools 90 may include a grabber/grasper tool and/or a plasma treatment tool. If there are multiple tools, the robot may be programmed to switch tools or rotate tools using the described QC or ATC components.

In at least one embodiment, the component 92 to be attached to the fascia 84 may be plasma and/or flame treated prior to attachment. The plasma/flame treatment may be performed by one of the adhesive robots or an adhesive robot may hold the component 92 to be treated under a plasma/flame treatment source. In one embodiment, the adhesive robots may include a plasma/flame treatment tool and may apply plasma/flame to the component 92. The plasma treatment may be an air plasma. The plasma/flame treatment may increase the surface energy of the component 92 such that an adhesive forms a better bond with the component 92. For example, the plasma/flame treatment may activate the surface of a polymer (e.g., polyolefin) such that a strong bond is created between the polymer and the adhesive. Since the system 70 includes multiple adhesive robots, each robot may perform the plasma/flame treatment step for one or more components 92 to be attached to the fascia 84. In another embodiment, the fascia 84 itself may be plasma/flame treated, either instead to or in addition to the component 92. The entire B-surface of the fascia 84 may be plasma/flame treated, or only the regions where the components 92 will be attached. The plasma/flame treatment may be performed by one of the adhesive robots 76, 78, or 80, or it may be performed by a separate robot.

After the (optional) plasma treatment has been performed, the adhesive robots may switch the tool 90 to a grabber tool (if not already selected). The grabber tool may then pick up the component 92 (e.g., a bracket for a sensor) and position it to receive an adhesive. For example, an adhesive dispenser (not shown) may be located within reach of the arm 86 and may be configured to dispense adhesive onto the component when the component 92 is in position. Since the system 70 includes multiple adhesive robots, each robot may perform the adhesive application step for one or more components 92 to be attached to the fascia 84. The adhesive dispenser may dispense the adhesive automatically or it may be manually activated. If automatic, the adhesive dispenser may have a motion detection system or the dispensing may be based on timing or other methods.

After the adhesive is applied to the component 92, the adhesive robot may place the component 92 in contact with the fascia 84 in the programmed location and hold it in place for a time sufficient for the adhesive to take effect. Since the system 70 includes multiple adhesive robots, each robot may perform the component placement step for one or more components 92 to be attached to the fascia 84. The hold time may depend on the adhesive, and may be programmed into the robot. Some adhesives may require a hold time sufficient for the adhesive to dry or cure, while others may only require partial drying or curing before the adhesive robot can cease to hold the component 92 in place. The robots may repeat the plasma, adhesive, and hold steps for each component 92 that is to be attached to the fascia 20. For example, if a fascia is configured to have five sensors, cameras, or other devices mounted thereto, the first adhesive robot 76 may sequentially plasma-treat one bracket, apply adhesive to the bracket, and hold the bracket in position. The second adhesive robot 78 may sequentially plasma-treat a bracket, apply adhesive to the bracket, and hold the bracket in position, and then repeat those steps one more time (one cycle for each bracket). The third adhesive robot 80 may perform the same steps as the second adhesive robot 78 to attach two components. Accordingly, the three adhesive robots may attach a total of five components 92 to the fascia 84.

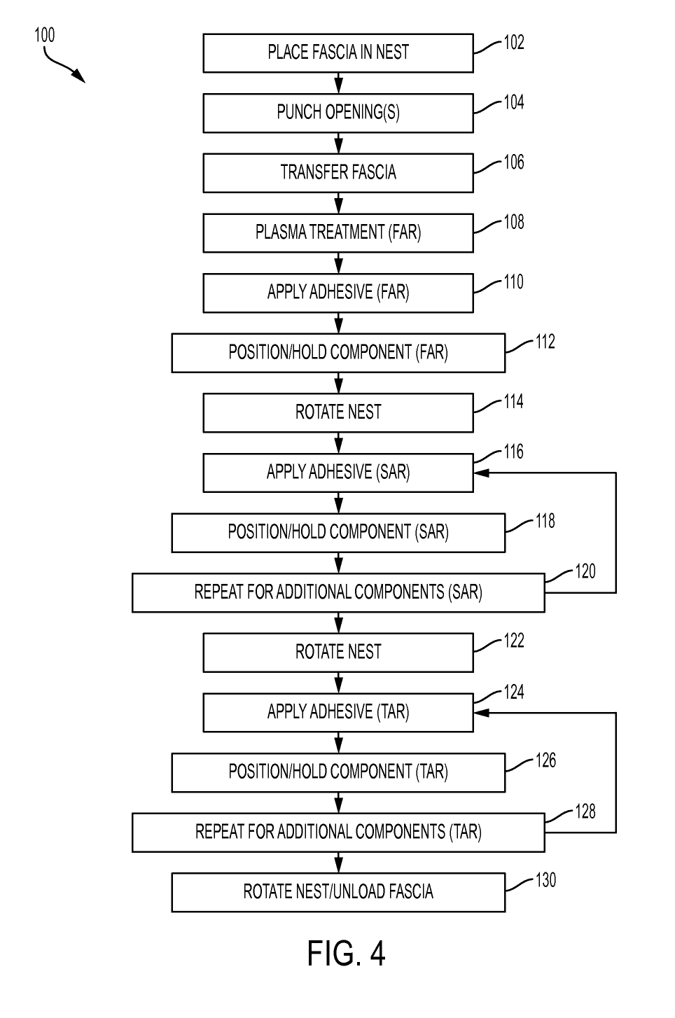

With reference to FIG. 4, an example flow chart 100 is shown for a method of operating the system shown 70 in FIG. 3. In step 102, a fascia may be loaded into a nest near or adjacent the punching robot. The fascia may be located anywhere with reach of the punching robot's arm, or even farther away if the robot is mobile. The fascia may be loaded manually by an operator or it may be loaded by a separate robot or other machinery. As part of step 102, an operator may also place or load the programmed number of components to be attached onto a nest. These brackets may be later attached to the fascia being loaded or to a different fascia, depending on the configuration of the system. In step 104, the punching robot may pick up the fascia (e.g., using a grasping/gripper tool) and may perform one or more punching operations. The punching robot may move the fascia to a different nest to perform the punching operations. As described above, the robot or the robot controller may be programmed with a certain number and location of punches. The punching robot may sequentially punch one or more holes/openings in the fascia.

After all the programmed punches have been made, the punching robot may move the punched fascia to a nest near or adjacent to the first adhesive robot (FAR) in step 106. Alternatively, the punched fascia may be moved manually or by a separate robot or machinery. In step 108, the FAR may plasma treat the fascia and/or the components to be attached (e.g., brackets). As described above, the plasma treatment may be performed by the FAR itself, or the FAR may hold the component in a location to receive a plasma treatment. The component and/or fascia may also come to the FAR pre-plasma treated.

In step 110, a first component to be attached may have adhesive applied thereto. As described above, the FAR may apply adhesive to the component via an EOAT or it may grip and hold the component under an adhesive dispenser. In step 112, the FAR may position/place and hold the component in a programmed location in contact with the fascia. The hold time may vary depending on the adhesive used. In step 114, the nest holding the fascia with the first component may be rotated or otherwise moved into position near or adjacent the second adhesive robot (SAR).

In step 116, a second component to be attached may have adhesive applied thereto. As described above, the SAR may apply adhesive to the component via an EOAT or it may grip and hold the component under an adhesive dispenser. In step 118, the SAR may position/place and hold the component in a programmed location in contact with the fascia. The hold time may vary depending on the adhesive used. In step 120, steps 116 and 118 may be repeated for a third component to be attached to the fascia. In step 122, the nest holding the fascia with the first, second, and third components may be rotated or otherwise moved into position near or adjacent the third adhesive robot (TAR).

In step 124, a fourth component to be attached may have adhesive applied thereto. As described above, the TAR may apply adhesive to the component via an EOAT or it may grip and hold the component under an adhesive dispenser. In step 126, the TAR may position/place and hold the component in a programmed location in contact with the fascia. The hold time may vary depending on the adhesive used. In step 128, steps 124 and 126 may be repeated for a fifth component to be attached to the fascia. In step 130, the nest holding the fascia with the five attached components may be rotated or otherwise moved to an unloading position or fixture. The completed (in terms of punching and component attachment) fascia may then be removed, either manually or by another robot or machinery.

It is to be understood that the flowchart 100 is merely exemplary, and the steps may be performed in a different order or certain steps may be performed simultaneously. The flowchart is described chronologically with reference to the punching and attachment of components to one fascia. However, one or more of the robots may be performing steps simultaneously on more than one fascia. For examples, as the punching robot is punching holes in one fascia, the FAR may be applying a bracket to a second fascia, the SAR may be applying a bracket to a third fascia, and the TAR may be applying a bracket to a fourth fascia. Alternatively, two robots may be working on the same fascia at the same time. For example, the SAR and TAR may be applying components #2 and #4 simultaneously (or at least overlapping).

While four robots are shown in system 70 and described in flowchart 100, there may be fewer or additional robots, or multiples of the robots (e.g., 2 sets of 4 robots, etc.). For example, if the punching operation is faster than the adhesive operation, then there may be more than the three adhesive robots shown in order to avoid bottlenecks. Two or more adhesive robots may apply components to a single fascia, or one robot may plasma treat while another applies adhesive and a third could position and hold the component in place. If the punching operation is slower than the adhesive operation, then additional punching robots could be included. A robot may be designated for plasma treating and/or applying adhesive, while other robot(s) position and hold the components. Based on the present disclosure, one of ordinary skill in the art may formulate different combinations of numbers of robots and their individual tasks. If greater production volumes are desired, then multiple production cells may be formed in the system. For example, there may be multiple sets of punching robots and adhesive robots performing the same tasks.

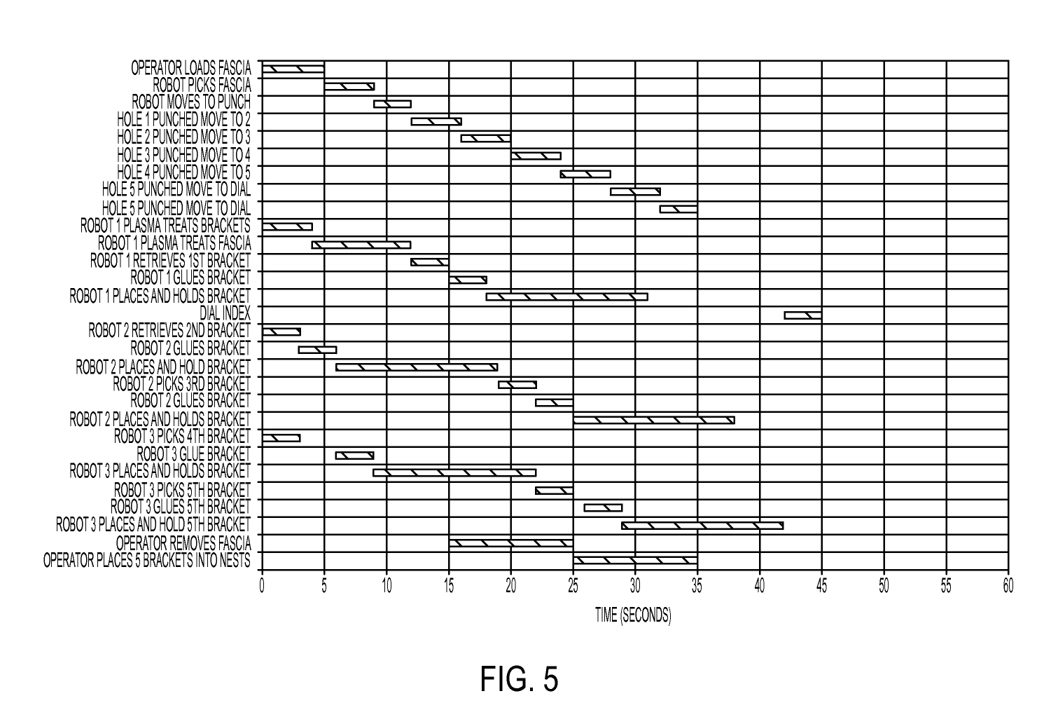

An example of a cycle time schedule for the system of FIG. 3 is shown in FIG. 5. As shown the operations of the different robots may be staggered or overlapping such that at the end of each cycle (about 45 seconds in the schedule shown), a fascia with five components attached is completed. The times shown for each step are merely examples, and may vary based on the type of adhesive, the number of robots, the number of components to be attached, or other factors. However, FIG. 5 shows that a single production cell of robots may punch and attach components to a fascia quickly and effectively. The production cell may punch and attach the components in less than a minute. If higher production volumes are desired, additional production cells can be put into service. Alternatively, the number of robots in the cell may be increased.

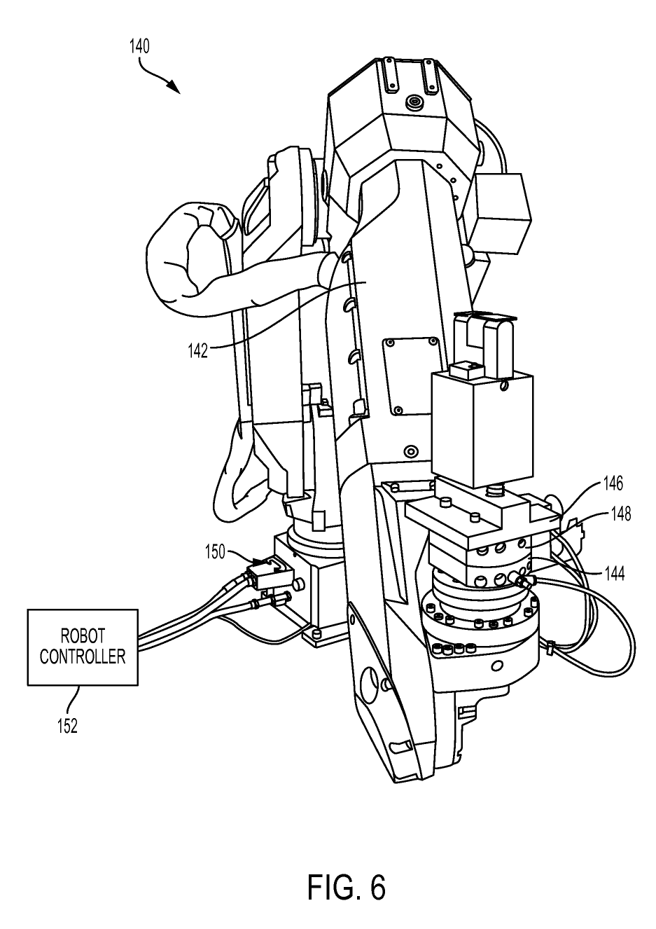

With reference to FIG. 6, an example of a robot 140 is shown that may be suitable for use as a punching and/or adhesive robot in the disclosed systems and methods. Robot 140 may include an arm 142 which may have multiple axes of rotation, such as 3, 4, 5, 6, 7, or more axes of rotation. The arm 142 may include a tool changer 144, which may be a quick change (QC) tool coupler or automatic tool changer (ATC). The tool changer 144 may allow the robot 140 to change tools quickly by either replacing the currently attached tool or by having more than one tool attached and rotating or otherwise switching between the tools. Attached to the tool changer 144 may be a tool 146 or multiple tools 146. The tool 146 may be attached to the tool changer 144 via a quick change tool coupler 148. For example, an adhesive robot may include a grabber/grasper tool and/or a plasma treatment tool and a punching robot may include a punching tool. If there are multiple tools 146, the robot may be programmed to switch tools or rotate tools using the described QC or ATC components. The robot 140 may also include electronics 150, which may include one or more cables that transfer power and data signals to the robot 140. For example, the robot 140 may be coupled to a robot controller 152, which may include a processor (e.g., microprocessor) and memory (e.g., transient and non-transient) configured and programmed to execute the disclosed functions (e.g., the steps in FIGS. 2 and 4).

The robot controller 152 may be reprogrammed when the configuration of the holes to be punched and/or the components to be attached to a fascia are changed. This reprogramming may take only a matter of hours or a single day and may not require any change in equipment, tooling, or materials. An engineer or programmer may program multiple fascia configurations into the robot such that switching between fascia configurations is simple, quick, and extremely cost effective, especially compared to sonic punch and weld fixtures that are inflexible and expensive. If the size or shape of an opening design is changed, a new tool (e.g. EOAT) may be required, however, a new tool is much less expensive and easier to store or re-use compared to an entire sonic punch/weld fixture.

As described above, the robots may be controlled by a robot controller or control system 152. The control system 152 may monitor and control operation of the systems (e.g., 10 and 70). For example, the control system may include at least one controller or control module that monitors and/or controls various components of the system 10, such as operation of the arms and end of arm tools (e.g., punching tool, gripping/grasping tool, and adhesive dispensing tool). The methods described, for example in FIGS. 2 and 4, may be performed with the systems 10 and 70. As will be appreciated by one of ordinary skill in the art, the flowcharts may represent or include control logic which may be implemented or affected in hardware, software, or a combination of hardware and software. For example, the various functions may be affected by a programmed microprocessor. The control logic may be implemented using any of a number of known programming and processing techniques or strategies and is not limited to the order or sequence illustrated. For instance, interrupt or event-driven processing may be employed in real-time control applications rather than a purely sequential strategy as illustrated. Likewise, parallel processing, multitasking, or multi-threaded systems and methods may be used.

Control logic may be independent of the particular programming language, operating system, processor, or circuitry used to develop and/or implement the control logic illustrated. Likewise, depending upon the particular programming language and processing strategy, various functions may be performed in the sequence illustrated, at substantially the same time, or in a different sequence while accomplishing the method of control. The illustrated functions may be modified, or in some cases omitted, without departing from the spirit or scope intended. In at least one embodiment, the method may be executed by the control system and may be implemented as a closed loop control system.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a first robot including a punching end of arm tool (EOAT) and configured to punch one or more openings in a vehicle fascia; and
a second robot configured to attach one or more components having an adhesive applied thereto to the vehicle fascia adjacent to the one or more openings.

2. The system of claim 1, wherein the first robot is configured to sequentially punch a plurality of openings in the vehicle fascia.

3. The system of claim 1, wherein the first robot is configured to punch the one or more openings at one or more variable locations on the vehicle fascia.

4. The system of claim 1, wherein the second robot is configured to apply the adhesive to the one or more components prior to attaching the one or more components to the vehicle fascia.

5. The system of claim 1, wherein the second robot is configured to hold the one or more components under an adhesive dispenser prior to attaching the one or more components to the vehicle fascia.

6. The system of claim 1, wherein the second robot is configured to plasma treat or flame treat at least one of the vehicle fascia and the one or more components prior to attaching the one or more components to the vehicle fascia.

7. The system of claim 1, wherein the second robot is configured to sequentially attach a plurality of components having an adhesive applied thereto to the vehicle fascia adjacent to the one or more openings.

8. The system of claim 1, wherein the second robot is configured to attach the one or more components having an adhesive applied thereto to the vehicle fascia at one or more variable locations on the vehicle fascia.

9. The system of claim 1, wherein the second robot is configured to switch between an adhesive dispensing EOAT and a grasping EOAT, wherein the second robot is configured to apply adhesive to the one or more components using the adhesive dispensing EOAT and to attach the one or more components using the grasping EOAT.

10. The system of claim 1, wherein the one or more components include sensor brackets and the second robot is configured to attach one or more components having a hot melt adhesive applied thereto to the vehicle fascia adjacent to the one or more openings.

11. A method comprising:
punching one or more openings into a vehicle fascia using a first robot end of arm tool (EOAT);
applying adhesive to one or more components; and
placing and holding the one or more components in contact with the vehicle fascia adjacent to the one or more openings using a second EOAT to attach the one or more components to the vehicle fascia.

12. The method of claim 11, wherein the punching step is performed by a first robot and the placing and holding step is performed by a second robot.

13. The method of claim 11, wherein the punching step includes sequentially punching a plurality of openings into the vehicle fascia using the first robot EOAT.

14. The method of claim 11, wherein the adhesive is applied to the one or more components by a third EOAT.

15. The method of claim 11, wherein the placing and holding step includes sequentially placing and holding a plurality of components in contact with the vehicle fascia adjacent to the one or more openings using a second EOAT.

16. The method of claim 11, wherein the adhesive is applied to the one or more components by an adhesive dispensing EOAT coupled to a robot and the placing and holding step is performed by the robot after the robot switches to a grasping EOAT.

17. The method of claim 11, wherein the applying step includes applying a hot melt adhesive to one or more components and the one or more components include sensor brackets.

18. A system comprising:
a first robot including a punching tool and configured to punch a plurality of openings in a vehicle fascia;
a second robot configured to attach one or more components having an adhesive applied thereto to the vehicle fascia adjacent to one of the openings; and
a third robot configured to attach one or more components having an adhesive applied thereto to the vehicle fascia adjacent to one of the openings.

19. The system of claim 18 further comprising a nest configured to receive the vehicle fascia from the first robot after the plurality of openings are punched and to hold the vehicle fascia while the second and third robots attach the one or more components.

20. The system of claim 19, wherein the nest is configured to move from the second robot to the third robot.
